(19) United States
(12) Patent Application Publication
(10) Pub. No.: US 2008/0083457 A1
(43) Pub. Date: Apr. 10, 2008

(54) VALVE ASSEMBLY FOR A MOTORCYCLE FUEL TANK

(75) Inventor: Joseph R. Konshak, Menomonee Falls, WI (US)

Correspondence Address: MICHAEL BEST & FRIEDRICH LLP, 100 E WISCONSIN AVENUE, Suite 3300, MILWAUKEE, WI, 53202, US

(73) Assignee: HARLEY-DAVIDSON MOTOR COMPANY GROUP, INC., Milwaukee, WI (US)

(21) Appl. No.: 11/539,194

(22) Filed: Oct. 6, 2006

(51) Int. Cl. F16K 17/36

(52) U.S. Cl. 137/39

(57) ABSTRACT

The present invention provides a valve assembly adapted to be coupled to a fuel tank of a motorcycle. The valve assembly includes a one-piece valve housing having a rollover valve housing portion at least partially defining a first chamber and a pressure relief valve housing portion at least partially defining a second chamber. The valve assembly also includes a rollover valve positioned in the first chamber and a pressure relief valve positioned in the second chamber.

### FIELD OF THE INVENTION

The present invention relates to motorcycles, and more particularly to fuel tanks for motorcycles.

### BACKGROUND OF THE INVENTION

Motorcycles typically include rollover valves incorporated within their fuel tanks. During substantially upright operation of the motorcycle, the rollover valve is normally open to allow accumulated fuel vapor in the fuel tank to pass outside of the fuel tank to the atmosphere or to a carbon canister emissions system. If the motorcycle is tipped on its side, the rollover valve closes to inhibit liquid fuel from spilling out of the fuel tank.

### SUMMARY OF THE INVENTION

The present invention provides, in one aspect, a valve assembly adapted to be coupled to a fuel tank of a motorcycle. The valve assembly includes a one-piece valve housing having a rollover valve housing portion at least partially defining a first chamber and a pressure relief valve housing portion at least partially defining a second chamber. The valve assembly also includes a rollover valve positioned in the first chamber and a pressure relief valve positioned in the second chamber.

The present invention provides, in another aspect, a fuel tank assembly adapted to be coupled to a motorcycle. The fuel tank assembly includes a fuel tank and a valve housing assembly coupled to the fuel tank. The valve housing assembly includes a one-piece valve housing having a rollover valve housing portion defining a first chamber and a pressure relief valve housing portion defining a second chamber. The valve housing assembly also includes a rollover valve positioned in the first chamber and a pressure relief valve positioned in the second chamber.

The present invention also provides, in another aspect, a fuel tank assembly that includes a fuel tank and a valve assembly coupled to the fuel tank. The valve assembly includes a rollover valve housing defining a first chamber, a pressure relief valve housing defining a second chamber, a rollover valve positioned in the first chamber, a pressure relief valve positioned in the second chamber, and a passageway communicating the first chamber and the second chamber. The passageway includes an outlet port.

Other features and aspects of the invention will become apparent by consideration of the following detailed description and accompanying drawings.

### BRIEF DESCRIPTION OF THE DRAWINGS

FIG. 1 is a perspective view of a motorcycle including a fuel tank, embodying the present invention.

FIG. 2 is a cutaway perspective view of the fuel tank of the motorcycle of FIG. 1, illustrating a valve assembly of the present invention.

FIG. 3 is an exploded perspective view of the valve assembly of FIG. 2.

FIG. 4 is an assembled bottom view of the valve assembly of FIG. 2.

FIG. 5 is a cross-sectional view taken along line 5-5 in FIG. 4, illustrating a vacuum valve in its closed state.

FIG. 6 is a view similar to FIG. 5, illustrating the vacuum valve in its opened state.

FIG. 7 is a cross-sectional view taken along line 7-7 in FIG. 4, illustrating a rollover valve in its opened state and a pressure relief valve in its closed state.

FIG. 8 is a view similar to FIG. 7, illustrating the rollover valve in its closed state and the pressure relief valve in its opened state.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports and couplings. Further, “connected” and “coupled” are not restricted to physical or mechanical connections or couplings.

### DETAILED DESCRIPTION

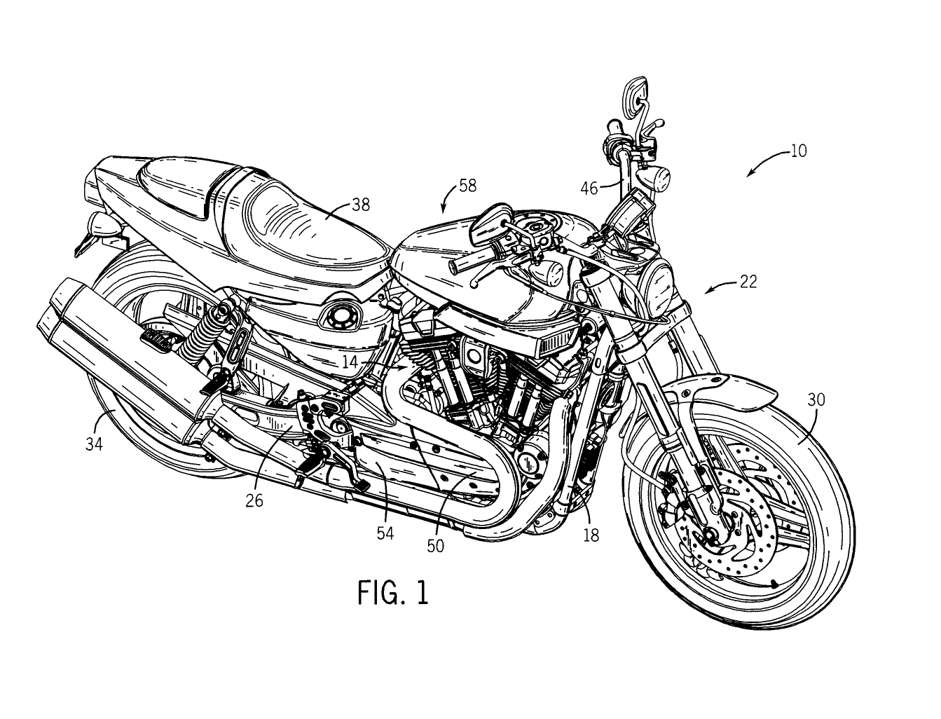

FIG. 1 illustrates a motorcycle 10 including a drive assembly 14, a frame 18, a front fork assembly 22, a swing arm or rear fork assembly 26, a front wheel 30, a rear wheel 34, a seat 38, and a fuel tank assembly 58. The frame 18 supports the drive assembly 14, the front fork assembly 22, the rear fork assembly 26, the seat 38, and the fuel tank assembly 58. The front fork assembly 22 is pivotally supported at a front end of the motorcycle 10 and supports the front wheel 30. The front fork assembly 22 includes a pair of handle bars 46 for steering the motorcycle 10. The rear fork assembly 26 is coupled to the frame 18 at a rear end of the motorcycle 10 and rotatably supports the rear wheel 34. The seat 38 is coupled to the frame 18 and is configured for supporting a rider. The fuel tank assembly 58 is supported by the frame 18 and provides fuel to the drive assembly 14.

The drive assembly 14 is preferably coupled to the frame 18 beneath the seat 38 between the front wheel 30 and the rear wheel 34 of the motorcycle 10. With continued reference to FIG. 1, the drive assembly 14 includes an engine 50 and a transmission 54. The engine 50 is a V-twin engine 50 and includes an output shaft (not shown), such as a crankshaft, which includes a primary drive sprocket (not shown) for driving a primary chain (not shown) in a conventional manner to power the transmission 54.

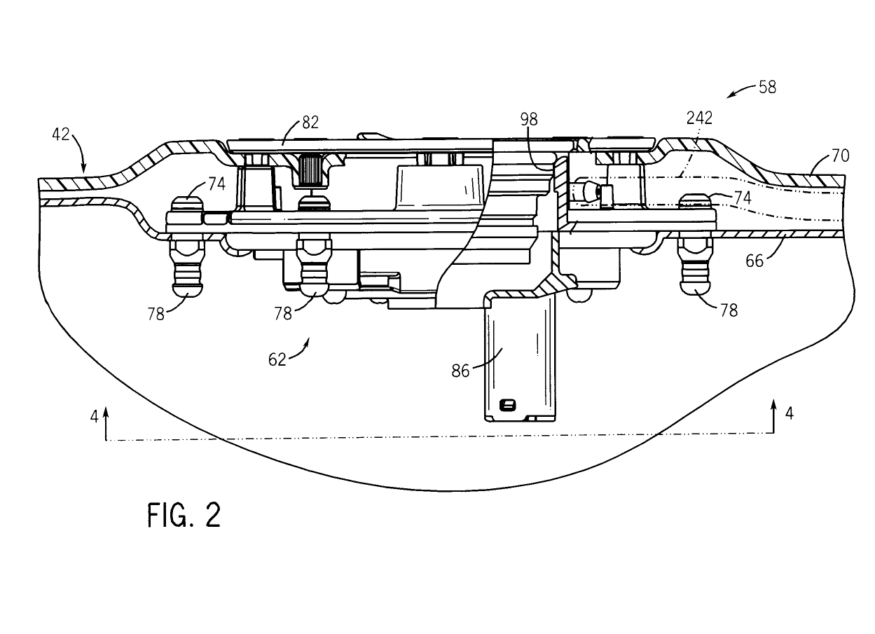

With reference to FIG. 2, the fuel tank assembly 58 includes a fuel tank 42 and a valve assembly 62. The fuel tank 42 is a two-piece design including a fuel bladder 66 and a cover 70. The fuel bladder 66 is made from a fuel-resistant plastic material (e.g., an acetal-based plastic), while the cover 70 is made from metal to shield the fuel bladder 66 from impacts and ultraviolet light from the sun. The cover 70 may also provide a decorative appearance to the fuel tank 42.

With continued reference to FIG. 2, the valve assembly 62 is coupled to the fuel bladder 66 by a plurality of fasteners (e.g., bolts 74) via a plurality of threaded inserts 78 molded into the fuel bladder 66. Alternatively, other types of fasteners (e.g., rivets) may be utilized to couple the valve assembly 62 to the fuel bladder 66, and the valve assembly 62 may be coupled to the fuel bladder 66 by any number of different ways including, among others, using a welding process (e.g., friction welding, RF-welding, etc.).

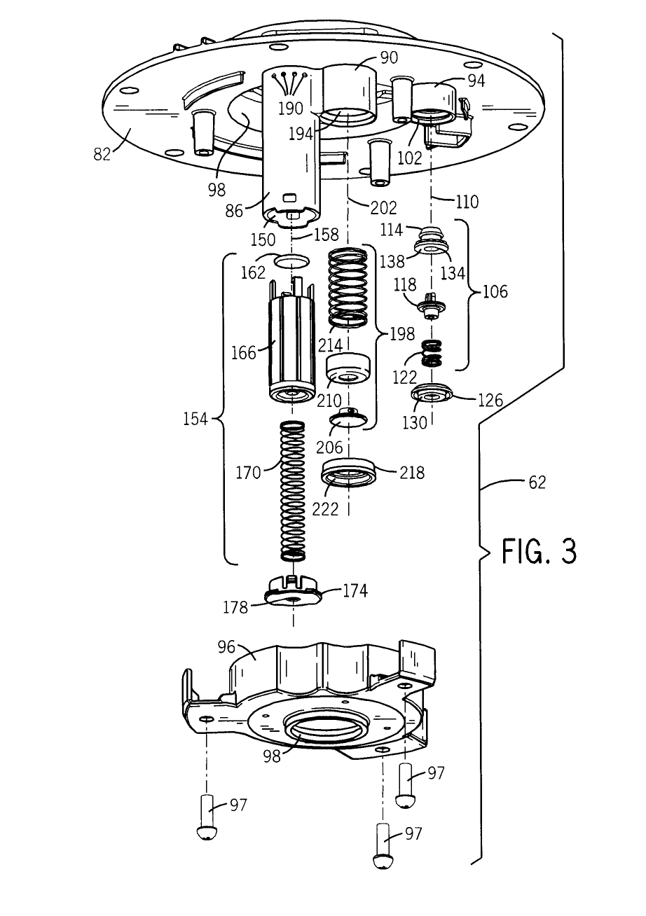

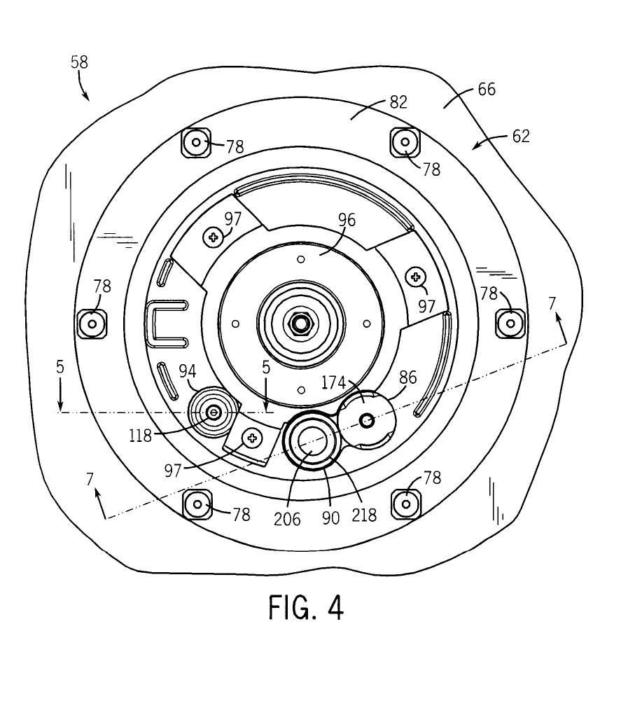

With reference to FIG. 3, the valve assembly 62 includes a one-piece valve housing 82 including a rollover valve housing portion 86, a pressure relief valve housing portion 90, and a vacuum valve housing portion 94, and a restrictor plate 96 coupled to the valve housing 82 by a plurality of fasteners (e.g., screws 97). In the illustrated construction of the one-piece valve housing 82, the rollover valve housing portion 86, the pressure relief valve housing portion 90, and the vacuum valve housing portion 94 are integrally formed as a single piece from a fuel-resistant plastic material (e.g., an acetal-based plastic). Alternatively, the vacuum valve housing portion 94 may be a separate and distinct component from the one-piece valve housing 82. As shown in FIG. 2, the one-piece valve housing 82 may also include a portion of a fuel inlet 98 through which fuel may pass to enter the fuel bladder 66. Further, the restrictor plate 96 may also include a portion of the fuel inlet 98.

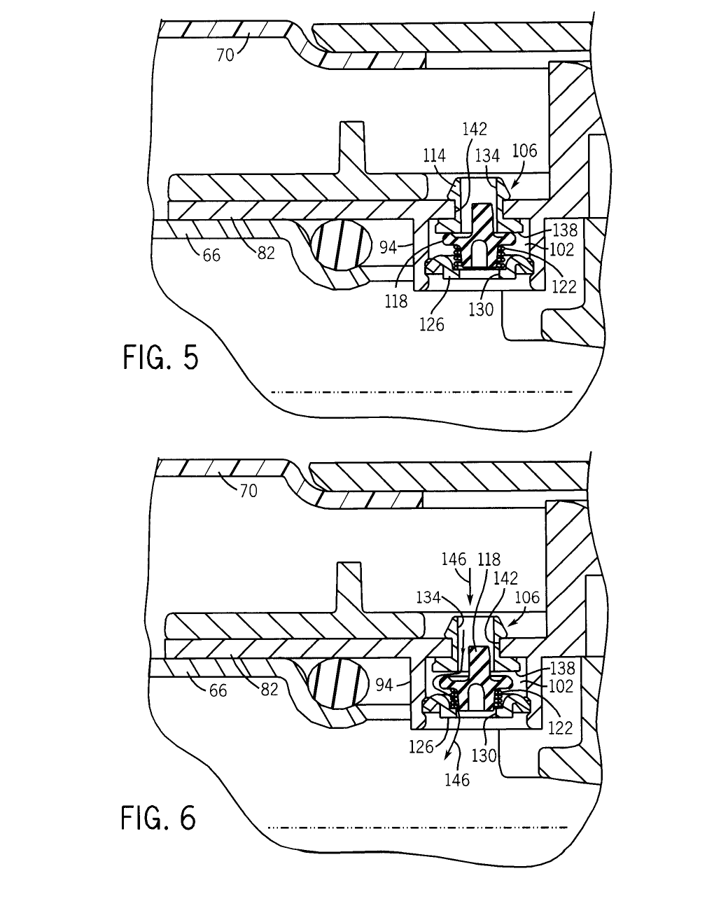

With reference to FIGS. 3 and 5, the vacuum valve housing portion 94 at least partially defines a chamber 102 in which a vacuum valve 106 is positioned. As shown in FIG. 3, the vacuum valve housing portion 94 defines a central axis 110 along which components of the vacuum valve 106 are positioned. The vacuum valve 106 includes a seal 114, a movable valve member 118 that selectively seals against the seal 114, and a compression spring 122 biasing the valve member 118 against the seal 114. An end cap 126 is coupled to the vacuum valve housing portion 94 to secure the vacuum valve 106 within the chamber 102. With reference to FIGS. 3, 5, and 6, the end cap 126 includes an aperture 130 aligned with the central axis 110 of the vacuum valve housing portion 94.

With reference to FIG. 5, the seal 114 includes a passageway 134 aligned with the central axis 110 and an end surface 138 that is selectively engaged by the valve member 118. During assembly of the valve assembly 62, the seal 114 is inserted through the chamber 102 along the central axis 110 and at least partially inserted through an aperture 142 in the one-piece valve housing 82 aligned with the central axis 110. After the seal 114 is inserted through the aperture 142, the valve member 118 and the compression spring 122 are inserted within the vacuum valve housing portion 94 along the central axis 110, and the end cap 126 is coupled to the vacuum valve housing portion 94 to secure the vacuum valve 106 within the chamber 102.

As fuel in the fuel bladder 66 is consumed during operation of the motorcycle 10, a vacuum may develop in the fuel bladder 66 due to the lost volume of the consumed fuel. With reference to FIG. 5, the vacuum valve 106 is normally closed such that the compression spring 122 biases the valve member 118 against the end surface 138 of the seal 114 to resist replacement air from entering the fuel bladder 66. With reference to FIG. 6, the valve member 118 unseats from the end surface 138 of the seal 114 upon the pressure differential between the outside replacement air (at atmospheric pressure) and the air/fuel vapor in the fuel bladder 66 overcoming the biasing force exerted by the compression spring 122. Replacement air (indicated by arrows 146) is then drawn from the space between the fuel bladder 66 and the cover 70, through the passageway 134 in the seal 114, around the unseated valve member 118, into the chamber 102, through the aperture 130 in the end cap 126, and into the fuel bladder 66. After the pressure in the fuel bladder 66 is equalized with the outside atmospheric pressure, the compression spring 122 again biases the valve member 118 against the end surface 138 of the seal 114 to seal the internal space of the fuel bladder 66 from the outside atmosphere.

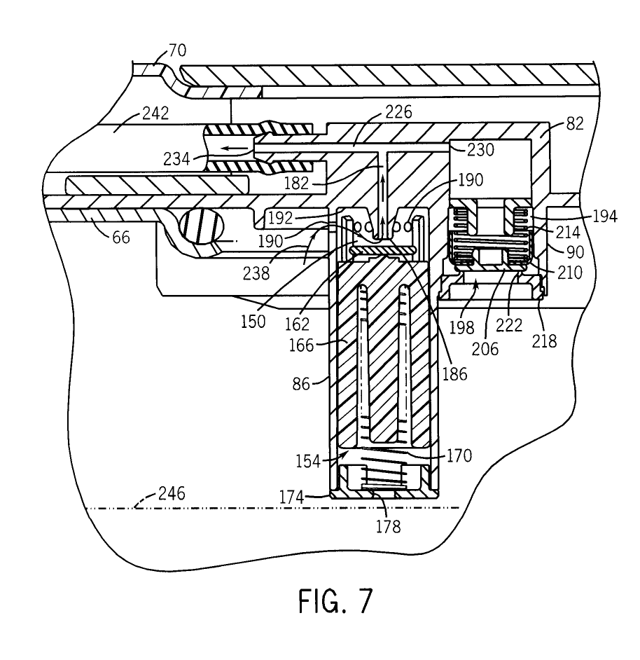

With reference to FIGS. 3 and 7, the rollover valve housing portion 86 at least partially defines a chamber 150 in which a normally-open rollover valve 154 is positioned. As shown in FIG. 3, the rollover valve housing portion 86 defines a central axis 158 along which components of the rollover valve 154 are positioned. The rollover valve 154 includes a seal 162, a movable valve member or float 166 that supports the seal 162, and a compression spring 170 supporting the float 166 in the chamber 150. An end cap 174 is coupled to the rollover valve housing portion 86 to secure the rollover valve 154 within the chamber 150. With reference to FIGS. 3, 7, and 8, the end cap 174 includes an aperture 178 aligned with the central axis 158 of the rollover valve housing portion 86.

With reference to FIG. 7, the one-piece valve housing 82 includes a passageway 182 aligned with the central axis 158 of the rollover valve housing portion 86 and an inlet port 186 in communication with the passageway 182. A plurality of inlet apertures 190 are formed in the rollover valve housing portion 86 at a location between the seal 162 and an upper end 192 of the chamber 150. In the illustrated construction of the one-piece valve housing 82, five inlet apertures 190 are formed in the rollover valve housing portion 86. Alternatively, more or fewer than five inlet apertures 190 may be utilized.

With reference to FIGS. 3 and 7, the pressure relief valve housing portion 90 at least partially defines a chamber 194 in which a normally-closed pressure relief valve 198 is positioned. As shown in FIG. 3, the pressure relief valve housing portion 90 defines a central axis 202 along which components of the pressure relief valve 198 are positioned. The pressure relief valve 198 includes a gasket 206, a backing member 210 that supports the gasket 206, and a compression spring 214 biasing the backing member 210 and the gasket 206 in a downward direction. The spring 214 is maintained at its opposite end by a spring retainer secured within the pressure relief valve housing portion 90. An end cap 218 is coupled to the pressure relief valve housing portion 90 to secure the pressure relief valve 198 within the chamber 194. As shown in FIG. 7, the gasket 206 is seated against the end cap 218 by a force exerted by the compression spring 214. With reference to FIGS. 3, 7, and 8, the end cap 218 includes an aperture 222 aligned with the central axis 202 of the pressure relief valve housing portion 90.

With reference to FIG. 7, the one-piece valve housing 82 includes a passageway 226, having an inlet port 230 and an outlet port 234, in communication with the chamber 194. The passageway 226 is also in communication with the chamber 150 via the passageway 182. As such, both passageways 182, 226 commonly share the outlet port 234. In the illustrated construction of the one-piece valve housing 82, the lengths of the passageways 182, 226 are reduced by positioning the rollover valve housing portion 86 adjacent the pressure relief valve housing portion 90. In other constructions, the rollover valve housing portion 86 and the pressure relief valve housing portion 90 may be spaced apart on the one-piece valve housing 82.

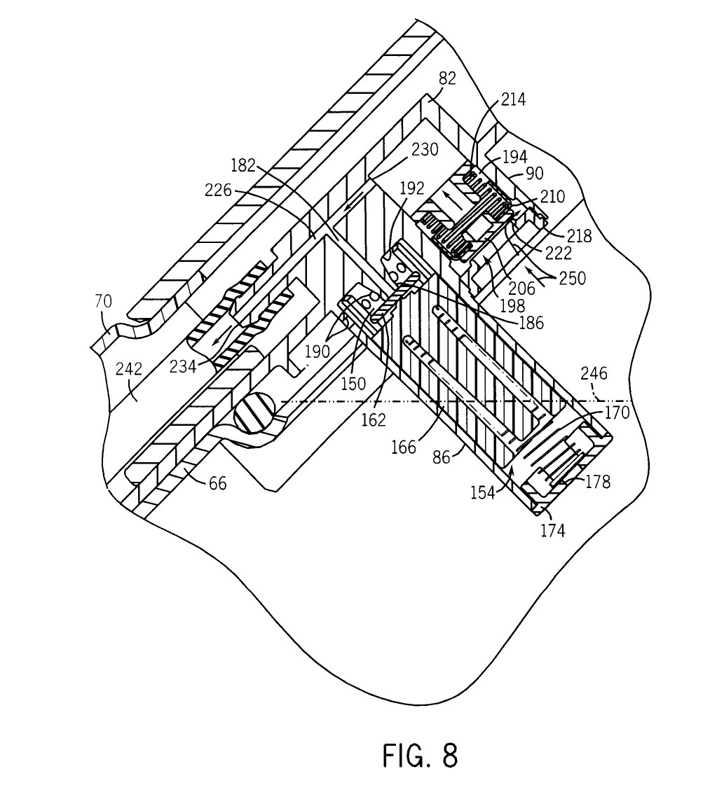

FIG. 7 illustrates the positioning of the rollover valve 154 and the pressure relief valve 198 during “normal” operation of the motorcycle 10. As used herein, “normal” motorcycle operation includes riding in a substantially upright manner and slight leaning, in which fuel in the fuel bladder 66 does not substantially slosh or enter the chamber 150 of the rollover valve housing portion 86. It should be understood that the amount of fuel that may enter the chamber 150 of the rollover valve housing portion 86 during normal motorcycle operation is dependent upon the level of fuel (indicated by line 246 in FIGS. 7 and 8) in the fuel bladder 66. In other words, operating the motorcycle 10 with a substantially empty fuel tank 42 may allow fuel in the fuel tank 42 to slosh more violently during cornering at relatively aggressive lean angles or aggressively braking, without a substantial amount of fuel entering the chamber 150.

During normal motorcycle operation, the float 166 and seal 162 are spaced from the inlet port 186 of the passageway 182. Accumulated fuel vapor in the fuel bladder 66 is allowed to pass through the inlet apertures 190 in the rollover valve housing portion 86 to enter the chamber 150 (see FIG. 7). From the chamber 150, the fuel vapor, under the action of a pressure differential between the chamber 150 and outside atmospheric pressure, passes through the inlet port 186, through the passageways 182, 226, and through the outlet port 234 (indicated by arrows 238). With reference to FIG. 2, a vent hose 242 is coupled to the one-piece valve housing 82 such that fuel vapor discharged from the outlet port 234 may be carried either to an emissions canister or to a remote location on the motorcycle 10 for discharge to atmosphere.

With reference to FIG. 7, the spring constant or the spring rate of the compression spring 170 is selected not to bias the float 166 and seal 162 against the inlet port 186 during normal motorcycle operation, but to balance the weight of the float 166 and seal 162 when the float 166 and seal 162 are spaced from the inlet port 186.

The spring constant or the spring rate of the compression spring 214 in the pressure relief valve 198, however, is selected in combination with the diameter of the gasket 206 to allow the gasket 206 to unseat from the end cap 218 upon reaching a predetermined pressure in the fuel bladder 66, or a “pressure relief set point.” For pressure to build in the fuel bladder 66, however, the rollover valve 154 must be closed so that accumulated fuel vapor in the fuel bladder 66 cannot escape through the apertures 190, the inlet port 186, the passageways 182, 226, and the outlet port 234. In the illustrated construction of the valve assembly 62, the pressure relief set point may be about 4 lbs/in². Alternatively, the pressure relief set point may be higher or lower than 4 lbs/in².

FIG. 8 illustrates an occurrence when the motorcycle 10 is leaned or tipped beyond what would be considered normal motorcycle operation. If the level of fuel (indicated by line 246) in the fuel bladder 66 is sufficiently high, leaning or tipping the motorcycle 10 causes liquid fuel to flood the chamber 150 of the rollover valve 154 through the aperture 178 in the end cap 174. The float 166 is made from a material that is buoyant in fuel (e.g., an acetal-based plastic), such that flooding the chamber 150 with fuel causes the float 166 to move upwardly to press the seal 162 against the inlet port 186 to resist liquid fuel from escaping the fuel bladder 66 through the inlet port 186, the passageways 182, 226, and the outlet port 234.

When the rollover valve 154 is closed, fuel vapor is also prevented from escaping the fuel bladder 66. However, intermittent closing of the rollover valve 154, resulting from intermittent flooding and draining of the rollover valve chamber 150, is not likely to cause a build-up of pressure in the fuel bladder 66 due to the accumulation of fuel vapor in the fuel bladder 66.

Pressure may build-up in the fuel bladder 66, for example, when the motorcycle 10 remains leaned or tipped for a long period of time in the orientation shown in FIG. 8. When the pressure relief set point is reached in the fuel bladder 66, the compression spring 214 allows the gasket 206 to unseat from the end cap 218, thereby allowing accumulated fuel vapor in the fuel bladder 66 to pass through the aperture 222 in the end cap 218, enter the chamber 194, pass between the gap between the backing member 210 and the pressure relief valve housing portion 90, through the inlet port 230, the passageway 226, and the outlet port 234 for discharge through the hose 242 (indicated by arrows 250). Because the rollover valve 154 and the pressure relief valve 198 both discharge fuel vapor through the passageway 226 and the outlet port 234, the rollover valve 154 and the pressure relief valve 198 may be considered to be positioned in parallel with each other. After equalization of the pressure in the fuel bladder 66 with the outside atmospheric pressure, the compression spring 214 may again seat the gasket 206 against the end cap 218 to close the pressure relief valve 198.

Various features of the invention are set forth in the following claims.

What is claimed is:

1. A valve assembly adapted to be coupled to a fuel tank of a motorcycle, the valve assembly comprising:
a one-piece valve housing including
a rollover valve housing portion at least partially defining a first chamber,
a pressure relief valve housing portion at least partially defining a second chamber,
a rollover valve positioned in the first chamber; and
a pressure relief valve positioned in the second chamber.

2. The valve assembly of claim 1, wherein the one-piece valve housing further includes a passageway communicating the first chamber and the second chamber.

3. The valve assembly of claim 2, wherein the one-piece valve housing further includes an outlet port in communication with the passageway.

4. The valve assembly of claim 1, wherein the pressure relief valve housing portion is positioned adjacent the rollover valve housing portion.

5. The valve assembly of claim 1, wherein the one-piece valve housing further includes a vacuum valve housing portion at least partially defining a third chamber, and wherein the valve assembly further includes a vacuum valve positioned in the third chamber.

6. The valve assembly of claim 1, wherein the one-piece valve housing further includes a fuel inlet through which fuel enters the fuel tank.

7. The valve assembly of claim 1, further comprising an end cap coupled to the rollover valve housing portion to secure the rollover valve in the first chamber, wherein the end cap includes an aperture therethrough to allow liquid fuel from the fuel tank to enter the first chamber.

8. The valve assembly of claim 1, wherein the rollover valve housing portion includes at least one aperture therethrough to allow fuel vapor from the fuel tank to enter the first chamber.

9. The valve assembly of claim 1, further comprising an end cap coupled to the pressure relief valve housing portion to secure the pressure relief valve in the second chamber, wherein the end cap includes an aperture therethrough to selectively allow fuel vapor from the fuel tank to enter the second chamber.

10. A fuel tank assembly adapted to be coupled to a motorcycle, the fuel tank assembly comprising:
a fuel tank;
a valve assembly coupled to the fuel tank, the valve assembly including
a one-piece valve housing including
a rollover valve housing portion defining a first chamber,
a pressure relief valve housing portion defining a second chamber;
a rollover valve positioned in the first chamber; and
a pressure relief valve positioned in the second chamber.

11. The fuel tank assembly of claim 10, wherein the one-piece valve housing further includes a passageway communicating the first chamber and the second chamber.

12. The fuel tank assembly of claim 11, wherein the one-piece valve housing further includes an outlet port in communication with the passageway.

13. The fuel tank assembly of claim 10, wherein the pressure relief valve housing portion is positioned adjacent the rollover valve housing portion.

14. The fuel tank assembly of claim 10, wherein the one-piece valve housing further includes a vacuum valve housing portion at least partially defining a third chamber, and wherein the valve assembly further includes a vacuum valve positioned in the third chamber.

15. The fuel tank assembly of claim 10, wherein the one-piece valve housing further includes a fuel inlet through which fuel enters the fuel tank.

16. The fuel tank assembly of claim 10, further comprising an end cap coupled to the rollover valve housing portion to secure the rollover valve in the first chamber, wherein the end cap includes an aperture therethrough to allow liquid fuel from the fuel tank to enter the first chamber.

17. The fuel tank assembly of claim 10, wherein the rollover valve housing portion includes at least one aperture therethrough to allow fuel vapor from the fuel tank to enter the first chamber.

18. The fuel tank assembly of claim 10, further comprising an end cap coupled to the pressure relief valve housing portion to secure the pressure relief valve in the second chamber, wherein the end cap includes an aperture therethrough to selectively allow fuel vapor from the fuel tank to enter the second chamber.

19. A fuel tank assembly adapted to be coupled to a motorcycle, the fuel tank assembly comprising:
a fuel tank;
a valve assembly coupled to the fuel tank, the valve assembly including
a rollover valve housing defining a first chamber,
a pressure relief valve housing defining a second chamber,
a rollover valve positioned in the first chamber,
a pressure relief valve positioned in the second chamber, and
a passageway communicating the first chamber and the second chamber, the passageway having an outlet port.

20. The fuel tank assembly of claim 19, further comprising a vent hose coupled to the outlet port.

21. The fuel tank assembly of claim 20, wherein the vent hose is adapted to be coupled to an emissions canister.

22. The fuel tank assembly of claim 19, wherein the pressure relief valve housing is positioned adjacent the rollover valve housing.

23. The fuel tank assembly of claim 19, wherein the rollover valve housing and the pressure relief valve housing are integrally formed as a single piece and together at least partially define a one-piece valve housing.

24. The fuel tank assembly of claim 23, wherein the one-piece valve housing further includes a vacuum valve housing at least partially defining a third chamber, and wherein the valve assembly further includes a vacuum valve positioned in the third chamber.

25. The fuel tank assembly of claim 23, wherein the one-piece valve housing further includes a fuel inlet through which fuel enters the fuel tank.
